(19) United States
(12) Patent Application Publication
(10) Pub. No.: US 2023/0011399 A1
(43) Pub. Date: Jan. 12, 2023

(54) Method, Apparatus, Electronic Device And Storage Medium For Processing Pixel Data

(71) Applicants: Beijing ESWIN Computing Technology Co., Ltd., Beijing (CN); Hefei ESWIN IC Technology Co., Ltd., Hefei City (CN)

(72) Inventors: Tae Jin Kim, Beijing (CN); Seungchan Byun, Beijing (CN)

(73) Assignees: Beijing ESWIN Computing Technology Co., Ltd., Beijing (CN); Hefei ESWIN IC Technology Co., Ltd., Hefei City (CN)

(21) Appl. No.: 17/394,885

(22) Filed: Aug. 5, 2021

(30) Foreign Application Priority Data
Jul. 6, 2021 (CN) 202110762246.2

(51) Int. Cl. G09G 3/20; H04N 1/32

(52) U.S. Cl. CPC G09G 3/2096; H04N 1/32283; G09G 2330/021; G09G 2300/0842

(57) ABSTRACT

Embodiments of the present application relate to the field of display driving technology, and disclose a method, an apparatus, an electronic device and a storage medium for processing pixel data. The method comprises: acquiring first image parameters of a first image unit and second image parameters of a second image unit, wherein the first image unit includes pixel data, of a first image, which is located on a first horizontal line, the second image unit includes pixel data, of a second image, which is located on the first horizontal line, and the second image is a previous frame of the first image; and updating the pixel data of the first image unit when the first image parameters do not match the second image parameters. The embodiments of the present application solve the problem of high driving power consumption in the process of outputting screens of the display panel in the prior art.

### CROSS-REFERENCE TO RELATED APPLICATIONS

This application claims priority from Chinese patent application number 202110762246.2, filed Jul. 6, 2021, the disclosure of which is hereby incorporated herein by reference.

### TECHNICAL FIELD

The present disclosure relates to the field of display driving technology, specifically, the application relates to a method, an apparatus, an electronic device and storage medium for processing pixel data.

### BACKGROUND ART

In the field of display technology, a screen output of a display panel is usually realized by processing screen data stored in an integrated circuit (IC). Through an image processing link, an output voltage is finally stored in a Storage Capacitor (Cst) of each pixel of the display panel, and the screen display is driven by driving methods using such as current (such as OLED) or voltage (such as LCD).

### SUMMARY OF THE INVENTION

The embodiments of the present application provide a method for processing pixel data to solve the problem of high driving power consumption in the process of outputting screens of the display panel in the prior art.

Correspondingly, the embodiments of the present application also provide a pixel data processing device, an electronic device, and a storage medium to ensure the implementation and application of the above method.

In order to solve the above-mentioned problem, an embodiment of the present application discloses a pixel data processing method, comprising:

acquiring first image parameters of a first image unit and second image parameters of a second image unit, wherein the first image unit includes pixel data, of a first image, which is located on a first horizontal line, the second image unit includes pixel data, of a second image, which is located on the first horizontal line, and the second image is a previous frame of the first image; and

updating the pixel data of the first image unit when the first image parameters do not match the second image parameters.

An embodiment of the present application further discloses an apparatus for processing pixel data, comprising:

a parameter acquisition module, configured to acquire first image parameters of a first image unit and second image parameters of a second image unit; wherein the first image unit includes pixel data, of a first image, which is located on a first horizontal line, the second image unit includes pixel data, of a second image, which is located on the first horizontal line, and the second image is a previous frame of the first image; and

a data updating module, configured to update the pixel data of the first image unit when the first image parameters do not match the second image parameters.

An embodiment of the present application further discloses a display, comprising the apparatus for processing pixel data described above.

An embodiment of the present application further discloses an electronic device, comprising:

a display, a memory, a processor and computer programs stored in the memory and executable by the processor, the processor is caused to perform one or more method in the embodiments of the present application.

An embodiment of the present application further discloses a computer-readable storage medium storing computer programs, and a processor is caused to perform one or more method in the embodiments of the present application when executing the computer programs.

The beneficial effects brought about by the technical solutions provided by the embodiments of the present application are:

in the embodiments of the present application, the first image parameters of the first image unit and the second image parameters of the second image unit are acquired, wherein the second image is a previous frame of the first image; the pixel data of the first image unit is updated when the first image parameters do not match the second image parameters, and the driving power consumption of the display panel is reduced by refreshing only the changed part of the display screen.

The additional aspects and advantages of the embodiments of the present application will be partly given in the following description, which will become obvious from the following description, or be understood through the practice of the present application.

### THE DESCRIPTION OF DRAWINGS

The above and/or additional aspects and advantages of the present application will become obvious and easy to be understood from the following description of the embodiments in conjunction with the accompanying drawings, wherein:

FIG. 1 is a flowchart of a method for processing pixel data according to an embodiment of the application;

FIG. 2 is a flowchart of a first example according to an embodiment of the application;

FIG. 3 is a flowchart of a second example according to an embodiment of the application;

FIG. 4 is a schematic structural diagram of an apparatus for processing pixel data according to an embodiment of the application;

FIG. 5 is a schematic structural diagram of an electronic device according to an embodiment of the application.

### DETAILED DESCRIPTION OF THE PREFERRED EMBODIMENT

Embodiments of the present invention will be described in detail hereinafter. The examples of these embodiments have been illustrated in the accompanying drawings throughout which same or similar reference numerals refer to same or similar elements or elements having same or similar functions. The embodiments described with reference to the accompanying drawings are illustrative, merely used for explaining the present invention and should not be regarded as any limitations thereto.

It should be understood by one person of ordinary skill in the art that singular forms “a”, “an”, “the”, and “said” may be intended to include plural forms as well, unless otherwise stated. It should be further understood that terms “comprise/comprising” used in this specification specify the presence of the stated features, integers, steps, operations, elements and/or components, but not exclusive of the presence or addition of one or more other features, integers, steps, operations, elements, components, and/or combinations thereof. It should be understood that, when a component is referred to as being “connected to” or “coupled to” another component, it can be directly connected or coupled to other elements or provided with intervening elements therebetween. In addition, “connected to” or “coupled to” as used herein can comprise wireless connection or coupling. As used herein, the term “and/or” comprises all or any of one or more associated listed items or combinations thereof.

It should be understood by one person of ordinary skill in the art that, unless otherwise defined, all terms (including technical and scientific terms) used herein have the same meaning as commonly understood by one person of ordinary skill in the art to which the present invention belongs. It should be further understood that terms, such as those defined in commonly used dictionaries, should be interpreted as having a meaning that is consistent with their meanings in the context of the prior art and will not be interpreted in an idealized or overly formal sense unless expressly so defined herein.

In the prior art, in the process of outputting a screen, a display panel has a high driving power consumption. Specifically, the pixel Cst capacity of the display panel is an important reference parameter of the Voltage Holding Ratio (VHR). Generally, the Cst capacity varies within 2% to 3%, and the pixel Cst capacity is determined by factors such as a driving frequency of the display panel, amount of leakage current of a connected Thin Film Transistor (TFT) switch and a drive output capability of the IC. In the operating state, it is necessary to periodically charge the Cst of the pixel according to the driving frequency of the display panel. Normally, if a Low Temperature Poly Silicon (LTPS) panel or an amorphous silicon (a-Si) panel is not charged periodically, poor screen display, such as flicker, screen brightness changes, or color changes may be caused.

In order to improve characteristics of the existing panels, the recently developed Oxide and Low Temperature Polycrystalline Oxide (LTPO) panels have attracted attention due to their good current mobility and current leakage characteristics. However, it also needs to periodically charge the Cst of the pixel, which leads to an increase in the driving power consumption of the display panel.

Therefore, in order to solve the above technical problems, the applicant proposes the technical solution of the present application to reduce driving power consumption.

The solutions according to the embodiments of the present application can be executed by any device with a display panel or a display, which may be but not limited to a terminal device, such as a smart phone, a tablet computer, a notebook computer, a desktop computer, etc.

The technical solutions of the present application and how the technical solutions of the present application solves the above technical problems will be described in detail below with specific embodiments. The following specific embodiments may be combined with each other, and the same or similar concepts or processes may not be repeated in some embodiments. The embodiments of the present application will be described below in conjunction with the accompanying drawings.

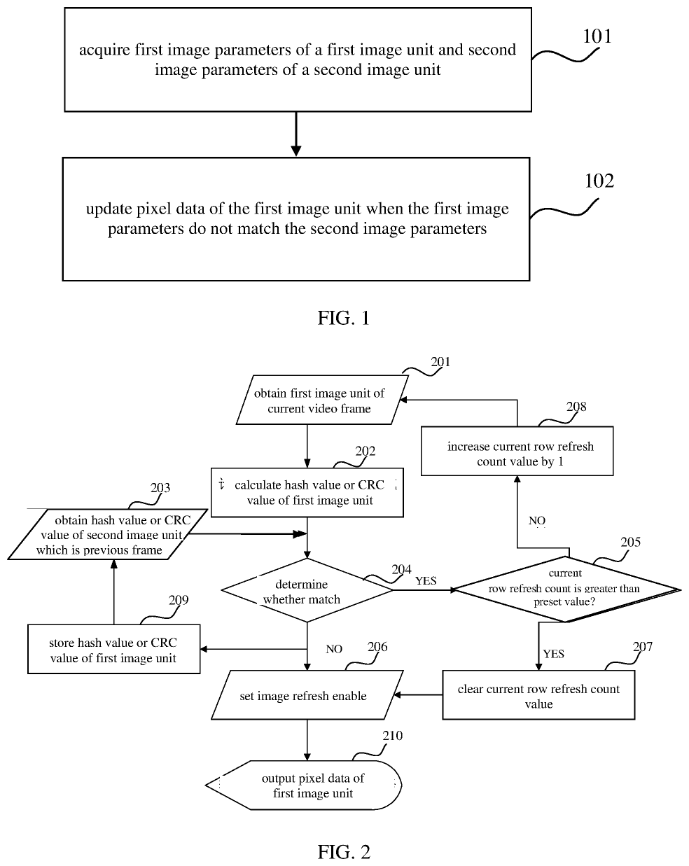

Referring to FIG. 1, an embodiment of the present application provides a method for processing pixel data, and the method comprises:

step 101: acquiring first image parameters of a first image unit and second image parameters of a second image unit, wherein the first image unit includes pixel data, of a first image, which is located on a first horizontal line, the second image unit includes pixel data, of a second image, which is located on the first horizontal line, and the second image is a previous frame of the first image.

For ease of description, taking applying the method to a display as an example in an embodiment of the present application, which is not limited to this. The first image unit may be a part of the pixel area or the entire pixel area on a display interface of the display, and the first image unit includes one or more pixel data on the first horizontal line. Optionally, the first horizontal line may be any horizontal line on the display interface, that is, the pixel data included in the first image unit is a row of pixels. Optionally, the first image and/or the second image may be part or all of the display screen of the display panel, respectively.

Optionally, in an embodiment of the present application, the horizontal line is a line perpendicular to a display positive direction of the display. For example, when the display direction of the display is vertical screen display, the horizontal line is a line perpendicular to the vertical screen direction; when the display direction of the display is horizontal screen direction, the horizontal line is a line perpendicular to the horizontal screen direction.

The first image unit is part or all of the pixel data, of the current image frame displayed on the display (i.e., the image frame displayed at the current moment), which is located on the first horizontal line, and the second image unit also includes part or all of the pixel data on the first horizontal line. That is, the second image unit is an image area corresponding to the first image unit in the previous frame of image, for example, the two have the same pixel coordinate area range.

Optionally, the image parameters may be pixel data of each pixel included in the image unit or other parameters obtained according to the pixel data.

Step 102: updating the pixel data of the first image unit when the first image parameters do not match the second image parameters.

Wherein, it is necessary to determine the mismatch between the first image parameter and the second image parameter according to type of each image parameter. For example, if the first image parameter and the second image parameter are both pixel data, if the pixel data of the two are different, it is confirmed that the first image parameter does not match the second image parameter. Alternatively, the first image parameter is pixel data, the second image parameter is another parameter. A obtained by performing data processing on the pixel data. If the other parameter B obtained by performing the same data processing on the pixel data of the first image parameter is different from the another parameter A, it is confirmed that the first image parameter does not match the second image parameter.

In an embodiment of the present application, the pixel data of the first image unit is updated, for example, the first image unit is refreshed, only when the first image parameter does not match the second image parameter. That is, the first image unit is refreshed only when the display screen of the first image unit changes. If the display screen has not changed, compared with the previous frame of image, the first image unit is not refreshed, so as to reduce the driving power consumption of the display panel. In an embodiment of the present application, for the display panel, which usually includes more pixel data, using pixels in a row as the refresh granularity to ensure that the changed part of the display screen is refreshed in real time and the unchanged part is not refreshed, which may not only ensure the image quality of the display panel, but also reduce the driving power consumption.

In an embodiment of the present application, the first image parameters of the first image unit and the second image parameters of the second image unit are acquired, wherein the second image is a previous frame of the first image; the pixel data of the first image unit is updated when the first image parameters do not match the second image parameters, and the driving power consumption of the display panel is reduced by refreshing only the changed part of the display screen. The embodiments of the present application solve the problem of high driving power consumption in the process of outputting screens of the display panel in the prior art.

In an optional embodiment, the first image parameters comprise the pixel data and/or a check parameter of the first image unit; and/or the second image parameters comprise the pixel data and/or a check parameter of the second image unit.

In other words, the first image parameter and the second image parameter may be data of different types, or may be data of the same type. For data of different types, for example, the first image parameter is pixel data, such as a gray value, and the second image parameter is other parameters calculated according to the gray value. For data of the same type, for example, the first image parameter and the second image parameter are other parameters calculated according to the gray value.

Optionally, in an embodiment of the present application, the check parameter includes a hash value of pixel data of a corresponding image unit. For example, the check parameter of the first image unit comprises a hash value of the pixel data of the first image unit, and the check parameter of the second image unit comprises a hash value of the pixel data of the second image unit. The space occupied by hash value data is usually much smaller than the space of the input data (i.e., the pixel data). For example, a hash value of a preset length is calculated from pixel data of any length through a hash algorithm to achieve compression mapping. For example, the pixel data is compressed into a function of a fixed-length message digest to reduce the storage space occupation.

Optionally, the hash value may include a Cyclic Redundancy Check (CRC) value, and a check code with a fixed number of bits is generated from the pixel data through cyclic redundancy check CRC, which is used to detect or check whether the first image parameter matches the second image parameter.

In an optional embodiment, the acquiring of the first image parameters of the first image unit and the second image parameters of the second image unit includes Case 1 and Case 2:

Case 1: acquiring the check parameter of the first image unit and the check parameter of the second image unit when an image frame memory is not included in the display.

Case 2: acquiring the pixel data of the first image unit, and acquiring the pixel data of the second image unit from the image frame memory, when the image frame memory is included in a display.

In Case 1, the check parameters of the first image unit and the second image unit are acquired when a frame memory is not included in the display; and whether the first image unit needs to be refreshed is determined according to the check parameters.

In Case 2, the pixel data of the first image unit and the second image unit are acquired when the frame memory is included in the display; and whether the first image unit needs to be refreshed is directly determined according to the pixel data.

As a first example, referring to FIG. 2 showing a specific example of Case 1, which mainly includes the following steps:

Step 201: obtain a first image unit of a current video frame.

The first image unit may be one row of pixel data.

Step 202: calculate a hash value or a CRC value of the first image unit.

Step 203: obtain a hash value or a CRC value of a second image unit which is a previous frame.

Step 204: determine whether the hash value or the CRC value of the first image unit matches the hash value or the CRC value of the second image unit; if the hash value or the CRC value of the first image unit matches the hash value or the CRC value of the second image unit, proceed to step 205, otherwise, proceed to step 206.

Step 205: if the hash value or the CRC value of the first image unit matches the hash value or the CRC value of the second image unit, indicating that the screen has not changed, in order to reduce the driving power consumption, the first image unit is not refreshed, and whether a current row refresh count value is greater than a preset threshold is determined. If the current row refresh count value is greater than the preset threshold, proceed to step 207 to clear the current row refresh count value, and proceed to step 206 to set an image refresh enable; otherwise, proceed to step 208 to increase the current row refresh count value by 1, and return to step 201. The preset threshold may be set for the display, and the previous refresh count value is increased by 1 whenever the step 205 is performed and the screen does not change.

Step 206: if the hash value or the CRC value of the first image unit does not match the hash value or the CRC value of the second image unit, the image refresh enable is set, and the refresh operation is performed on the first image unit.

Step 209: store the hash value or the CRC value of the first image unit for use in an image refresh determination for a next frame.

Step 210: output the pixel data of the first image unit.

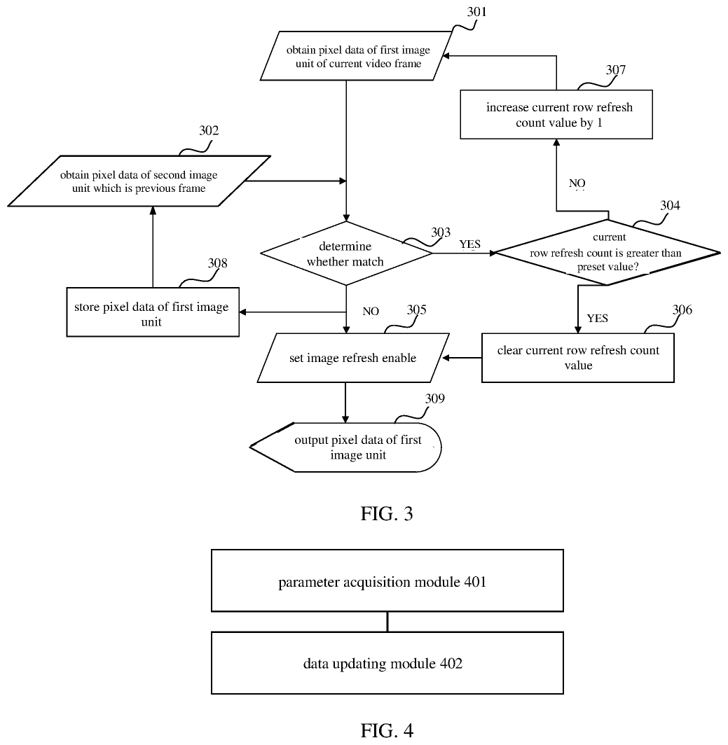

As a second example, referring to FIG. 3 showing a specific example of Case 2, which mainly includes the following steps:

Step 301: obtain pixel data of a first image unit of a current video frame.

Step 302: obtain pixel data of a second image unit which is a previous frame.

Step 303: determine whether the pixel data of the first image unit matches the pixel data of the second image unit: if the pixel data of the first image unit matches the pixel data of the second image unit, proceed to step 304, otherwise, proceed to step 305.

Step 304, if the pixel data of the first image unit matches the pixel data of the second image unit, indicating that the screen has not changed, in order to reduce the driving power consumption, the first image unit is not refreshed, and whether a current row refresh count value is greater than a preset threshold is determined. If the current row refresh count value is greater than the preset threshold, proceed to step 306 to clear the current row refresh count value, and proceed to step 305 to set an image refresh enable; otherwise, proceed to step 307 to increase the current row refresh count value by 1, and return to step 301. The preset threshold may be set for the display, and the previous refresh count value is increased by 1 whenever the step 304 is performed and the screen does not change.

Step 305, if the pixel data of the first image unit does not match the pixel data of the second image unit, the image refresh enable is set, and the refresh operation is performed on the first image unit.

Step 308: store the pixel data of the first image unit for use in an image refresh determination for a next frame.

Step 309: output the pixel data of the first image unit.

In an optional embodiment, the first image and/or the second image include at least a part and/or all of a display interface of a display. The first image and/or the second image may be a partial area or all of a display screen of a display panel, respectively. For a partial area, it is possible to achieve that only to refresh a partial screen of the display.

In an optional embodiment, when the first image parameters match the second image parameters, performing at least one of operations of: controlling a charging source amplifier Source amp to stop outputting power to a source line of a display panel of a display and/or a pixel storage capacitor; and reducing power of the Source amp.

It should be noted that the power consumption of the driver IC is usually concentrated on power consumption of processing the internal image of the IC, power consumption of the source line of the display panel, and power consumption of driving the Source amp used to charge the pixel Cst. In an embodiment of the present application, when the first image parameters match the second image parameters, in order to further reduce the driving power consumption, at least one of the above operations is also performed. For example, stop charging the source line of the display panel by using the Source amp (that is, outputting power), stop charging the Cst pixel by using the Source amp, or reduce or even completely clear the power of the Source amp, thereby reducing the power consumption of the driver IC.

In an embodiment of the present application, the first image parameters of the first image unit and the second image parameters of the second image unit are acquired, where the second image is a previous frame of the first image; the pixel data of the first image unit is updated when the first image parameters do not match the second image parameters; the pixel data of the first image unit is not updated when the first image parameters match the second image parameters, and the driving power consumption of the display panel is further reduced by outputting the Source line and the Source amp. The embodiments of the present application solve the problem of high driving power consumption in the process of outputting screens of the display panel in the prior art.

Based on the same principle as the method according to embodiments of the present application, the embodiments of the present application also provides an apparatus for processing pixel data.

As shown in FIG. 4, the apparatus comprises: a parameter acquisition module 401 and a data updating module 402.

The parameter acquisition module 401 is configured to acquire first image parameters of a first image unit and second image parameters of a second image unit; wherein the first image unit includes pixel data, of a first image, which is located on a first horizontal line, the second image unit includes pixel data, of a second image, which is located on the first horizontal line, and the second image is a previous frame of the first image.

The first image unit may be a part of the pixel area or the entire pixel area on a display interface of the display, and the first image unit includes one or more pixel data on the first horizontal line. Optionally, the first horizontal line may be any horizontal line on the display interface, that is, the pixel data included in the first image unit is a row of pixels.

Optionally, in an embodiment of the present application, the horizontal line is a line perpendicular to a display positive direction of the display. For example, when the display direction of the display is vertical screen display, the horizontal line is a line perpendicular to the vertical screen direction; when the display direction of the display is horizontal screen direction, the horizontal line is a line perpendicular to the horizontal screen direction.

The first image unit is part or all of the pixel data, of the current image frame displayed on the display (i.e., the image frame displayed at the current moment), which is located on the first horizontal line, and the second image unit also includes part or all of the pixel data on the first horizontal line. That is, the second image unit is an image area corresponding to the first image unit in the previous frame of image, for example, the two have the same pixel coordinate area range.

Optionally, the image parameters may be pixel data of each pixel included in the image unit or other parameters obtained according to the pixel data.

The data updating module 402 is configured to update the pixel data of the first image unit when the first image parameters do not match the second image parameters.

Wherein, it is necessary to determine the mismatch between the first image parameter and the second image parameter according to type of each image parameter. For example, if the first image parameter and the second image parameter are both pixel data, if the pixel data of the two are different, it is confirmed that the first image parameter does not match the second image parameter. Alternatively, the first image parameter is pixel data, the second image parameter is another parameter A obtained by performing data processing on the pixel data. If the other parameter B obtained by performing the same data processing on the pixel data of the first image parameter is different from the another parameter A, it is confirmed that the first image parameter does not match the second image parameter.

In an embodiment of the present application, the pixel data of the first image unit is updated, for example, the first image unit is refreshed, only when the first image parameter does not match the second image parameter. That is, the first image unit is refreshed only when the display screen of the first image unit changes. If the display screen has not changed, compared with the previous frame of image, the first image unit is not refreshed, so as to reduce the driving power consumption of the display panel. In an embodiment of the present application, for the display panel, which usually includes more pixel data, using pixels in a row as the refresh granularity to ensure that the changed part of the display screen is refreshed in real time and the unchanged part is not refreshed, which may not only ensure the image quality of the display panel, but also reduce the driving power consumption.

In an embodiment of the present application, the first image parameters of the first image unit and the second image parameters of the second image unit are acquired by the parameter acquisition module 401, wherein the second image is a previous frame of the first image; the pixel data of the first image unit is updated by the data updating module 402 when the first image parameters do not match the second image parameters, and the driving power consumption of the display panel is reduced by refreshing only the changed part of the display screen. The embodiments of the present application solve the problem of high driving power consumption in the process of outputting screens of the display panel in the prior art.

In an optional embodiment, the first image parameters comprise the pixel data and/or a check parameter of the first image unit; and/or the second image parameters comprise the pixel data and/or a check parameter of the second image unit.

In an optional embodiment, the parameter acquisition module 401 comprises:

a first acquisition submodule, configured to acquire the pixel data of the first image unit, and acquire the pixel data of the second image unit from an image frame memory, when the image frame memory is included in a display; and

a second acquisition submodule, configured to acquire the check parameter of the first image unit and the check parameter of the second image unit when the image frame memory is not included in the display.

In an optional embodiment, the check parameter comprises a hash value of pixel data of corresponding image unit.

In an optional embodiment, the hash values comprise Cyclic Redundancy Check (CRC) values.

In an optional embodiment, the first image and/or the second image include at least a part and/or all of a display interface of a display.

In an optional embodiment, the apparatus further comprise an execution module, when the first image parameters match the second image parameters, the execution module is configured to perform at least one of operations of:

controlling a charging source amplifier Source amp to stop outputting power to a source line of a display panel of a display and/or a pixel storage capacitor; and

reducing power of the Source amp.

The apparatus for processing pixel data according to the embodiments of the present application can implement the various processes implemented in the method embodiments in FIGS. 1-3, and to avoid repetition, details are not described.

The apparatus for processing pixel data according to the embodiments of the present application can execute the method for processing pixel data according to the embodiments of the present application, and its implementation principles are similar. The actions executed by various modules and units in the apparatus for processing pixel data in the embodiments of the present application are corresponding to the steps in the method for processing pixel data in each embodiment of the present application. For the detailed description to the function of each module of the apparatus for processing pixel data, please refer to the corresponding description in the method for processing pixel data in the previous section, which will not be repeated here.

In the embodiments of the present application, the first image parameters of the first image unit and the second image parameters of the second image unit are acquired by the parameter acquisition module 401, wherein the second image is a previous frame of the first image; the pixel data of the first image unit is updated by the data updating module 402 when the first image parameters do not match the second image parameters; the pixel data of the first image unit is not updated when the first image parameters match the second image parameters, and the driving power consumption of the display panel is further reduced by the way of outputting the source line and the Source amp.

Based on the same principle as the method shown in the embodiments of the present application, the embodiments of the present application also provides a display including the apparatus for processing pixel data described above.

Based on the same principle as the method shown in the embodiments of the present application, the embodiments of the present application also provides an electronic device. The electronic device may include, but is not limited to, a display, a processor, and a memory; the memory is configured to store computer programs; the processor is configured to execute perform the method for processing pixel data in any optional embodiment of the present application by calling the computer programs. Compared with the prior art, the electronic device obtains the first image parameters of the first image unit and the second image parameters of the second image unit, wherein the second image is a previous frame of the first image; updates the pixel data of the first image unit when the first image parameters do not match the second image parameters, and reduces the driving power consumption of the display panel by refreshing only the changed part of the display screen.

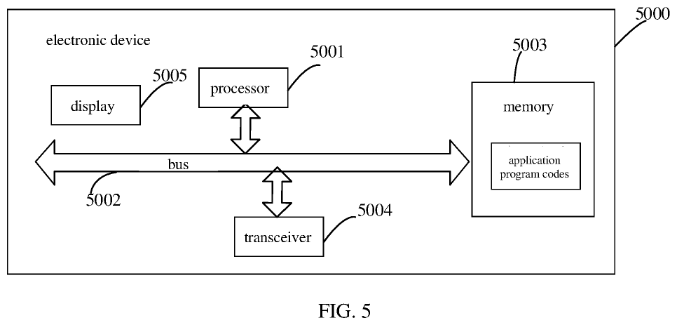

In an optional embodiment, an electronic device is also provided, as shown in FIG. 5. the electronic device 5000 shown in FIG. 5 may be a server, including but not limited to, a mobile terminal equipment such as a mobile phone, a notebook computer, a digital broadcast receiver, a PDA (personal digital assistant), a PAD (tablet computer), a PMP (portable multimedia player), a vehicle terminal (such as a vehicle navigation terminal), and a fixed terminal equipment such as a digital TV, a desktop computer, and the like. The server includes a display 5005, a processor 5001, and a memory 5003. Wherein, the processor 5001 and the memory 5003 are connected, for example, through a bus 5002. Optionally, the electronic device 5000 may further include a transceiver 5004. It should be noted that in actual applications, the number of the transceiver 5004 is not limited to one, and the structure of the electronic device 5000 does not constitute a limitation to the embodiments of the present application.

The processor 5001 may be a CPU (Central Processing Unit), a general-purpose processor, a DSP (Digital Signal Processor), an ASIC (Application Specific Integrated Circuit), and an FPGA (Field Programmable Gate Array) or other programmable logic devices, transistor logic devices, hardware components or any combination thereof. It can implement or execute various exemplary logical blocks, modules, and circuits described in conjunction with the disclosure of the present application. The processor 5001 may also be a combination for realizing calculation functions, for example, including a combination of one or more microprocessors, a combination of a DSP and a microprocessor, and the like.

The bus 5002 may include a path for transferring information between the above-mentioned components. The bus 5002 may be a PCI (Peripheral Component Interconnect) bus or an EISA (Extended Industry Standard Architecture) bus or the like. The bus 5002 may be divided into an address bus, a data bus, a control bus, and the like. For ease of representation, only one thick line is used in FIG. 5 to represent the bus 5002, but it does not mean that there is only one bus or one type of bus.

The memory 5003 may be ROM (Read Only Memory) or other types of static storage devices that may store static information and instructions, RAM (Random Access Memory) or other types of dynamic storage devices that may information and instructions. Alternatively, the memory 5003 may also be an EEPROM (Electrically Erasable Programmable Read Only Memory), a CD-ROM (Compact Disc Read Only Memory) or other optical disk storages, optical disk storages (including compressed Optical discs, laser discs, optical discs, digital versatile discs, Blu-ray discs, etc.), magnetic disk storage media or other magnetic storage devices, or any other medium that may be used to carry or store desired program codes in the form of instructions or data structures and can be accessed by a computer, but not limited to these.

The memory 5003 is used to store application program codes for executing the solutions of the present application, which is controlled by the processor 5001 to be executed. The processor 5001 is configured to execute the application program codes stored in the memory 5003 to implement the content shown in the foregoing method embodiments.

Wherein, the electronic device includes, but is not limited to, a mobile terminal such as a mobile phone, a laptop, a digital broadcast receiver, a PDA (personal digital assistant), a PAD (tablet computer), a PMP (portable multimedia player), a vehicle terminal (such as a vehicle navigation terminal), etc., or a fixed terminal such as a digital TV, a desktop computer, etc.

The electronic device shown in FIG. 5 is only an example, and should not bring any limitation to the function and scope of use of the embodiments of the present application.

The server provided in the present application may be an independent physical server, a server cluster or a distributed system composed of multiple physical servers, or a cloud server that provides cloud services.

The embodiments of the present application provide a computer-readable storage medium with a computer program stored thereon, and when it runs on a computer, the computer is caused to execute the corresponding content in the foregoing method embodiments.

It should be understood that although steps in the flowchart of the drawings are sequentially showed in accordance with the directions of arrows, these steps are not necessarily executed in sequence in the order indicated by the arrows. Unless explicitly stated herein, the execution order of these steps is not strictly limited, and they may be executed in other orders. Moreover, at least part of the steps in the flowchart of the drawings may include a plurality of sub-steps or a plurality of stages that are not necessarily performed at the same time and may be performed at different times, and these sub-steps or stages is not necessarily performed sequentially, but may be performed alternately with other steps or at least a part of the sub-steps or stages of other steps.

It should be noted that the above-mentioned computer-readable storage medium of the present application may also be a computer-readable signal medium or a combination of a computer-readable storage medium and a computer-readable storage medium. The computer-readable storage medium may be, for example, but not limited to, an electrical, magnetic, optical, electromagnetic, infrared, or semiconductor system, apparatus, or device, or a combination thereof. More specific examples of the computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical memory device, a magnetic memory device, or any suitable combination thereof. In the present application, the computer-readable storage medium may be any tangible medium that contains or stores a program, and the program may be used by or in combination with an instruction execution system, apparatus, or device. In the present application, the computer-readable signal medium may include data signals propagated in baseband or as a part of a carrier, and computer-readable program codes are carried therein.

This propagated data signals may be in many forms, including but not limited to, electromagnetic signals, optical signals, or any suitable combination thereof. The computer-readable signal medium may also be any computer-readable medium other than the computer-readable storage medium. The computer-readable signal medium may transmit, propagate, or transfer the programs for use by or in combination with the instruction execution system, apparatus, or device. The program codes contained on the computer-readable medium may be transferred by any suitable medium, including but not limited to, a wire, an optical cable, a RF (Radio Frequency), etc., or any suitable combination thereof.

The above-mentioned computer-readable medium may be included in the above-mentioned electronic device, or may exist alone without being assembled into the electronic device.

The above-mentioned computer-readable medium carries one or more programs that, when executed by the electronic device, cause the electronic device to execute the method in the foregoing embodiments.

According to one aspect of the present application, a computer program product or computer program is provided. The computer program product or computer program includes computer instructions, which are stored in a computer-readable storage medium. The processor of the computer device reads the computer instructions from the computer-readable storage medium, and the processor executes the computer instructions, so that the computer device executes the method for processing pixel data provided in the various optional implementation manners described above.

The computer program codes used to perform the operations of the present application may be written in one or more programming languages or a combination thereof. The above-mentioned programming languages include object-oriented programming languages, such as Java, Smalltalk, C++, and also include conventional procedural programming language, such as “C” language or similar programming language. The program codes may be executed entirely on a user's computer, partly on the user's computer, executed as an independent software package, partly on the user's computer and partly on a remote computer, or entirely executed on the remote computer or a server. In the case of the remote computer, the remote computer may be connected to the user's computer through any kind of network, including a local area network (LAN) or a wide area network (WAN), or may be connected to an external computer (for example, using an Internet connection provided by an Internet service provider).

The flowcharts and block diagrams in the accompanying drawings illustrate the possible implementation of the system architecture, functions, and operations of the system, method, and computer program product according to various embodiments of the present application.

In this regard, each block in the flowcharts or block diagrams may represent a module, a program segment, or a part of codes, which contains one or more executable instructions for realizing the specified logical function. It should also be noted that, in some alternative implementations, the functions marked in the block may also occur in a different order from the order marked in the drawings. For example, two blocks shown in succession may actually be executed substantially in parallel, and sometimes may be executed in a reverse order, depending on the functions involved. It should also be noted that each block in the block diagrams and/or flowcharts, and the combination of the blocks in the block diagrams and/or flowcharts, may be implemented by a dedicated hardware-based system that performs the specified functions or operations, or may be implemented by a combination of dedicated hardware and computer instructions.

The modules involved in the embodiments described in the present application may be implemented in software or hardware. Wherein, the name of the module does not constitute a limitation on the module itself under certain circumstances. For example, module A can also be described as “module A configured to perform operation B”.

The above description is only for explanation of preferred embodiments of the present application and the applied technical principles. Those skilled in the art should understand that the scope of disclosure involved in the present application is not limited to the technical solutions formed by the specific combination of the above technical features, and should also cover other technical solutions formed by arbitrarily combining the above technical features or the equivalent features without departing from the above disclosed concept. For example, the above-mentioned features and the technical features disclosed in the present application (but not limited to) with similar functions are mutually replaced to form a technical solution.

1. A method for processing pixel data, comprising:
acquiring a check parameter of a first image unit and a check parameter of a second image unit as a first image parameter of the first image unit and a second image parameter of the second image unit, respectively, if an image frame memory is not included in a display, wherein the first image unit includes pixel data, of a first image, which is located on a first horizontal line, the second image unit includes pixel data, of a second image, which is located on the first horizontal line, and the second image is a previous frame of the first image, and the check parameter comprises a hash value of pixel data of corresponding image unit; and
updating the pixel data of the first image unit when the first image parameter-does not match the second image parameter, or
determining whether a current row refresh count value is greater than a preset threshold when the first image parameter matches the second image parameter.

2. (canceled)

3. (canceled)

4. (canceled)

5. The method for processing pixel data according to claim 1, wherein the hash values comprise Cyclic Redundancy Check (CRC) values.

6. The method for processing pixel data according to claim 1, wherein the first image and/or the second image include at least a part and/or all of a display interface of the display.

7. The method for processing pixel data according to claim 1, when the first image parameter matches the second image parameter, further comprising performing at least one of following operations: for the first image unit,
controlling a charging source amplifier Source amp to stop outputting power to a source line of a display panel of a display and/or a pixel storage capacitor; and
reducing power of the Source amp.

8. An apparatus for processing pixel data, comprising:
one or more processors;
a memory, configured to store computer programs, when executed by the one or more processors cause the one or more processors to:
acquire a check parameter of a first image unite and a check parameter of a second image unit as a first image parameter of the first image unit and a second image parameter of the second image unit, respectively, if an image frame memory is not included in a display; wherein the first image unit includes pixel data, of a first image, which is located on a first horizontal line, the second image unit includes pixel data, of a second image, which is located on the first horizontal line, and the second image is a previous frame of the first image, the check parameter comprises a hash value of pixel data of corresponding image unit;
update the pixel data of the first image unit when the first image parameter does not match the second image parameter; or
determine whether a current row refresh count value is greater than a preset threshold when the first image parameter matches the second image parameter.

9. (canceled)

10. (canceled)

11. The apparatus for processing pixel data according to claim 8, wherein the first image and/or the second image include at least a part and/or all of a display interface of the display.

12. The apparatus for processing pixel data according to claim 8, when the first image parameters match the second image parameters, the one or more processors are further caused to perform at least one of following operations when executing the computer programs: for the first image unit,
controlling a charging source amplifier Source amp to stop outputting power to a source line of a display panel of a display and/or a pixel storage capacitor; and
reducing power of the Source amp.

13. (canceled)

14. (canceled)

15. A display, comprising the apparatus for processing pixel data according to claim 8.

16. (canceled)

17. (canceled)

18. An electronic device, comprising: a display, a memory, a processor and computer programs stored in the memory and executable by the processor, the processor is caused to perform the method according to claim 1 when executing the computer programs.

19. A non-transitory computer-readable storage medium storing computer programs, and a processor is caused to perform the method according to claim 1 when executing the computer programs.

20. The method for processing pixel data according to claim 1, further comprising:
clearing the current row refresh count value and setting an image refresh enable when it is determined that the current row refresh count value is greater than the preset threshold.

21. The method for processing pixel data according to claim 1, further comprising:
increasing the current row refresh count value by 1 when it is determined that the current row refresh count value is not greater than the preset threshold.

22. The apparatus for processing pixel data according to claim 8, the one or more processors are further caused to, when executing the computer programs:
clear the current row refresh count value and set an image refresh enable when it is determined that the current row refresh count value is greater than the preset threshold.

23. The apparatus for processing pixel data according to claim 8, the one or more processors are further caused to, when executing the computer programs:
increase the current row refresh count value by 1 when it is determined that the current row refresh count value is not greater than the preset threshold.
